(19) United States
(12) Patent Application Publication
(10) Pub. No.: US 2010/0202339 A1
(43) Pub. Date: Aug. 12, 2010

(54) MESSAGE BROADCASTING

(76) Inventors: Heng T. Chieng, Kuala Lumpur (MY); Kee N. Ting, Kuala Lumpur (MY); Rafeeza B. Rahim, Kuala Lumpur (MY)

Correspondence Address: NIXON & VANDERHYE, PC, 901 NORTH GLEBE ROAD, 11TH FLOOR, ARLINGTON, VA, 22203, US

(21) Appl. No.: 12/671,268

(22) PCT Filed: Jul. 30, 2008
(86) PCT No.: PCT/GB2008/002595

§ 371 Date: Jan. 29, 2010

(30) Foreign Application Priority Data
Jul. 31, 2007 (MY) PI 2007 1260

(51) Int. Cl. H04H 20/71

(52) U.S. Cl. 370/312

(57) ABSTRACT

A system for broadcasting user messages in a wireless network, said system comprising an access point and a plurality of clients, wherein each client comprises: a processing unit for receiving a message input by a user, a generator for generating a beacon frame comprising said input message, and a broadcast means for broadcasting said generated beacon frame; and wherein each access point comprises: a receiver for receiving broadcast beacon frames, and a broadcast means for rebroadcasting said received beacon frames.

### FIELD OF THE INVENTION

The present invention relates to a system and method for broadcasting user messages in a wireless network, in particular a system and method for broadcasting user messages using beacon frames in a wireless network.

### BACKGROUND TO THE INVENTION

The IEEE 802.11 standard, more commonly referred to as Wi-Fi, for Wireless Local Area Networks (WLANs) has been rapidly adopted by many users seeking to implement wireless telecommunications networks. Wi-Fi networks are starting to provide wireless networking for an ever increasing number of users, with some urban and suburban areas having a significant density of wireless access points (WAPs) per geographical area. It is likely that in the future, we will see even more WAPs in residential, enterprise and public places, supporting increasing user density and traffic loads. The density of WAPs in many areas may even reach a state when each WAP will be able to communicate wirelessly with a neighbouring WAP, with the relative distance between WAPs decreasing.

Communications between WAPs and clients in a WLAN arrangement can be broadly split into two categories: control messaging and data messaging. Control messages are used to support standard network operations such as handshaking and for establishing a network connection. They usually contain lower network layer information e.g. physical or link layer signaling information. Data messages on the other hand contain messages that will eventually be received by applications in the client terminal. Data messages usually originate from applications running on client terminals and require a network connection to be first established between the client and any receiving party. Examples of such an application include instant messaging applications such as Yahoo Messenger. In these arrangements, messaging in WLANs clearly rely on a prior network connection between parties before a suitable messaging application can be run.

In US patent application 2005/0286456, a method for sending messages in beacon frames is described. The method uses an adapted processor added to WAPs for generating and broadcasting messages in beacon frames in a WLAN arrangement. The method reuses the service set identity SSID field, which is usually used for identifying the specific WLAN, for storing the message to be broadcast to clients. However, the method is limited to suitably configured WAPs and only allows for messages to be broadcast from a WAP to a client, without any further propagation. Thus, only users with the range of the WAP in question can receive the broadcast messages.

### SUMMARY OF THE INVENTION

It is the aim of embodiments of the present invention to address at least some of the above stated problems and also to generally provide an improved method of broadcasting messages in a wireless network.

According to one aspect of the present invention, there is provided a system for broadcasting user messages in a wireless network, said system comprising an access point and a plurality of clients, wherein each client comprises: a processing unit for receiving a message input by a user, a generator for generating a beacon frame comprising said input message, and a broadcast means for broadcasting said generated beacon frame; and wherein each access point comprises: a receiver for receiving broadcast beacon frames, and a broadcast means for rebroadcasting said received beacon frames.

Preferably, each client further comprises a receiver for receiving broadcast beacon frames.

The processing unit in each client can be further adapted to extract the message from the received beacon frame.

The generated beacon frame may comprise a beacon identifier field for indicating that the beacon frame contains a user input message.

The receiver in the access point may be adapted to detect the beacon identifier and then extract the message from the received beacon frame.

Preferably, the wireless network is a local area network, and the input message is embedded in a service set identifier field of the beacon frame.

In a preferred embodiment, the message is compressed in the beacon frame. The message may also be encoded in the generated beacon frame using an associated message code.

The message and associated message code may be stored at a message server for retrieval by a client receiving the beacon frame comprising the message code.

According to a second aspect of the present invention, there is provided a method of broadcasting user messages in a wireless network comprising an access point and a plurality of clients, wherein said method comprises: receiving by a first client a message input by a user, generating by the first client a beacon frame comprising said input message, broadcasting by the first client said generated beacon frame, receiving by the access point the broadcast beacon frames, and rebroadcasting by the access point the received beacon frames.

According to a third aspect of the present invention, there is provided a client module for a client in a wireless network comprising: a processing unit for receiving a message input by a user, a generator for generating a beacon frame comprising said input message, and a broadcast means for broadcasting said generated beacon frame; wherein the broadcast beacon frame is for reception and rebroadcasting by an access point in the wireless network.

The system enables broadcasting of customized messages between clients across a large geographical area or over multiple WLANs using special beacon frames. The system does not require that the clients have a network connection to a WAP in a traditional network sense, and hence does not disrupt the existing operation of WLANs.

Embodiments of the invention use only very small customised messages, or special beacon frames, which place a minimal overhead on the network. Furthermore, the arrangement can be configured to broadcast the special beacon frames less frequently than normal beacons, thus further reducing traffic overheads.

Embodiments of the invention have the further advantage in that they do not affect the existing IEEE 802.11 WLAN operation. Those WAPs that do not wish to participate in broadcasting these customized messages can simply choose to ignore them.

In summary, embodiments of the invention enable customized messages to be propagated across a large geographical area such as residential areas, commercial zones, urban, etc. Such messages could be traffic announcements, commercial adverts, event announcements, etc. These messages can be broadcasted to any mobile clients within the wireless transmission range regardless of whether they are connected to a WAP or not. Hence, any wireless Internet Service Provider can take advantage of this opportunity to broadcast special messages to any mobile clients within the range even though they may not be subscribing or connected clients.

### BRIEF DESCRIPTION OF THE DRAWINGS

For a better understanding of the present invention reference will now be made by way of example only to the accompanying drawings, in which:

FIG. 1 is a WLAN arrangement in an embodiment of the present invention;

FIG. 2 is a modified SSID field in an embodiment of the present invention;

FIG. 3 is a mobile client module in an embodiment of the present invention;

FIG. 4 is WAP beacon processing module in an embodiment of the present invention;

FIG. 5 is flow chart illustrating the generating and processing of special beacon frames in an embodiment of the present invention;

FIG. 6 illustrates a WLAN arrangement divided into separate zones;

FIG. 7 illustrates the online message retrieval feature in an embodiment of the invention.

### DESCRIPTION OF THE PREFERRED EMBODIMENTS

The present invention is described herein with reference to particular examples. The invention is not, however, limited to such examples.

Embodiments of the present invention system are based on reusing the beacon frames specified in the IEEE802.11 standards.

Beacon frames already form an important part of the operation of a WLAN, and are generally used for announcing the existence of a network as well as providing information for other network maintenance tasks. They are transmitted at regular intervals by a WAP to allow mobile stations (or clients) to locate and identify a network, and for allowing a client to connect to the network.

One of the fields in the beacon frame is the service set identity (SSID) field, which is typically 32 bytes long and transmitted at regular intervals by WAPs to advertise themselves. The SSID is included in a beacon frame broadcast by WAPs. Clients in the vicinity of a WAP can scan for this beacon frame and discover the SSID being broadcast by the WAP. The client then uses this SSID to connect to the WAP. If that particular WAP is security protected, the client will need to have the right to access it, for example by using a username, password, wireless network card authentication etc.

In embodiments of the present invention, the beacon frame, and in particular the SSID field, is used for user-specified messaging initiated by clients for reception by other clients. Clients suitably configured are capable of generating user-specified messages, which are inserted into the SSID field of a beacon frame, and broadcasted by the client. These “special” beacon frames are rebroadcast by suitably configured WAPs for reception by its neighbouring nodes, which may include further WAPs or other clients.

Using this method, user-customized messages can be easily propagated across multiple WAPs or indeed across multiple WLANs, which may be over a large geographical area.

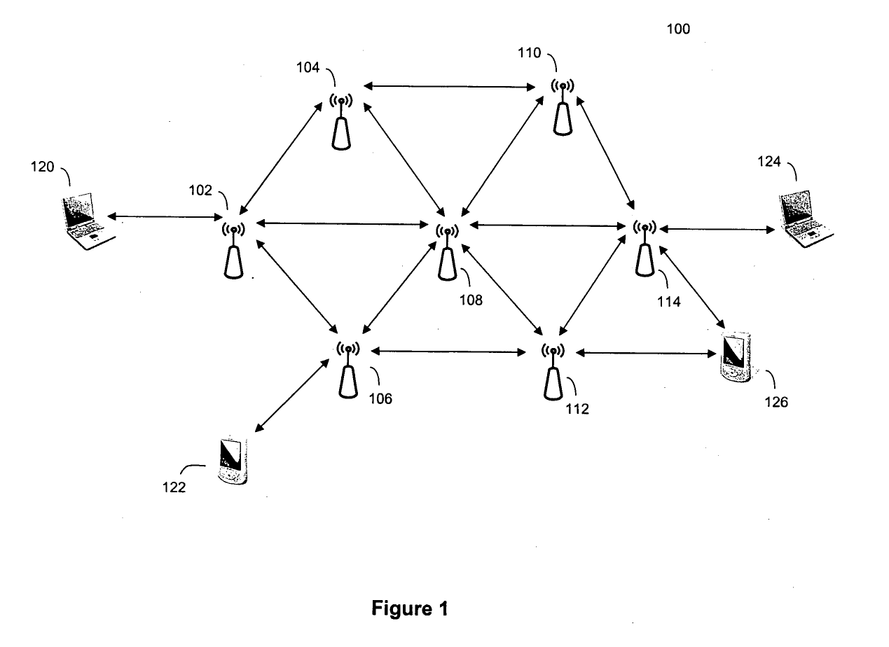

FIG. 1 illustrates a wireless network arrangement 100 in an embodiment of the present invention. The network 100 is a WLAN network operating in accordance with the IEEE 802.11 standard. The network 100 comprises a number of wireless access points (WAPs) 102, 104, 106, 108, 110, 112 and 114. The wireless coverage area of the network 100 is defined by the coverage area of the individual WAPs, with each WAP having its own transmission range and associated coverage area. Each WAP operates in accordance with the wireless IEEE 802.11 standard and may also have connections with a backhaul wired network, such as a Ethernet LAN or ADSL connection. However, the type of wired connection that the WAPs have is not critical to the operation of the present invention. The important features, which relate to the wireless communication aspects, will become apparent in the discussions that follow.

Also shown in FIG. 1 are various mobile stations 120, 122, 124 and 126. These mobile stations may be for example a laptop, PDA or mobile phone that includes a suitable network interface card enabling the mobile device to communicate wirelessly with the WAPs.

Each WAP is able to communicate wirelessly with other WAPs in its coverage area using the IEEE 802.11 standard. In this example, WAP 102 is able to communicate with WAP 104, WAP 106 and WAP 108. Similarly, WAP 104 is able to communicate with WAP 102, WAP 108 and WAP 110.

The mobile devices in FIG. 1 are also able to communicate with selected WAPs depending on their location and proximity to a particular WAP. For example, laptop 120 is able to communicate with WAP 102 only. However, PDA 126 is able to communicate with both WAP 112 and WAP 114, as it is situated in the coverage area of both.

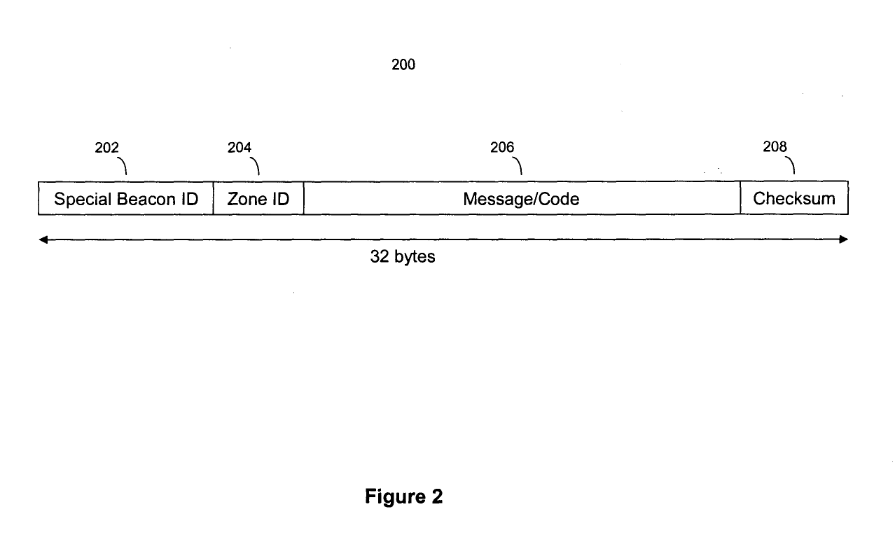

Present invention reuses the beacon frame specified in the IEEE 802.11 standard. The beacon frame contains many fields. One is the SSID field, which effectively identifies a particular network as described above (expand). Embodiments of the present invention specify the use of the beacon frame for broadcasting user-specified messages from a client for receipt by other clients, where the messages are received and retransmitted by WAPs. FIG. 2 shows the adapted SSID field in an embodiment of the present invention.

FIG. 2 illustrates the adapted SSID field 200 in an embodiment of the present invention. The SSID field 200 comprises a special beacon ID subfield 202, a zone ID subfield 204, a message/code subfield 206 and a checksum subfield 208. Each of these fields will be described below. However, a person skilled in the art will appreciate that not all the subfields are essential to the operation of the invention.

The special beacon ID subfield 202 is used to identify a special beacon frame, and differentiate it from a normal beacon frame. This subfield 202 is filled with a predetermined code that would not be used in a normal SSID field such, as the binary sequence 10101010. Thus, clients and WAPs with prior knowledge of this special sequence will be able to determine when the beacon frame is a special beacon frame or when it is a normal beacon frame, and process the frame accordingly.

The zone ID subfield 204 is used for propagation control to limit the range of special beacon frames that are being broadcast. This is based on each WAP in the network having a zone ID relating to a specific geographical area. WAPs having a different zone ID to that identified in the zone ID subfield 204 are designed not to retransmit the special beacon frame containing the user-generated message.

The message/code subfield 206 is used to store user-generated messages. The format of the data in the message/code subfield 206 can take various forms, such as raw ASCII, compressed or coded messages.

The checksum field 208 serves several purposes. The first is to ensure that the adapted SSID field 200 does not contain any errors. It can also serve as a unique identifier for the special beacon frame, and thus can be used to prevent repeat broadcasting of the same message by a WAP. This can help to avoid the same message being bounced back and forth between a pair of WAPs for example and overloading the network. Of course, any given WAP can decide to rebroadcast a special beacon frame a certain number of times, but the WAP can still use the checksum to identify whether the message has been processed before.

In one embodiment of the invention, the checksum is a cyclic redundancy check (CRC). A CRC is a type of hash function that generates a small, fixed number of bits based on an input data block, such as a network data packet.

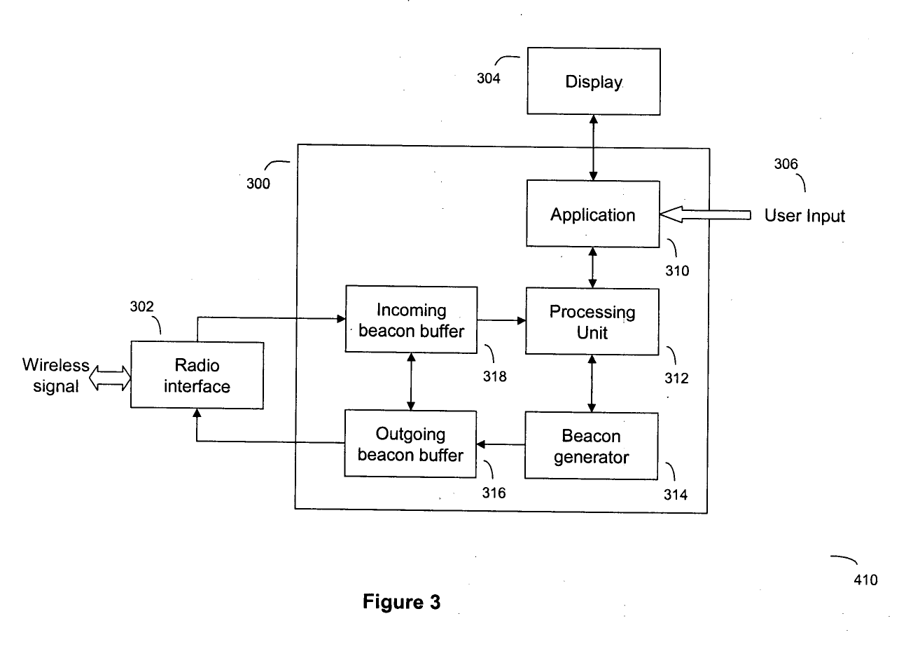

Normally, the beacon frame is broadcast by WAPs only for reception by clients. In the present invention, a client module is proposed that allows a client to generate special beacon frames as shown in FIG. 2 for broadcasting user-messages. FIG. 3 illustrates the mobile client module 300 in an embodiment of the present invention.

The client module 300 can be implemented on any mobile device such as a laptop, smartphone or PDA, and is capable of both generating special beacon frames 200 as well as receiving special beacon frames 200. The client module 300 integrates with the client's radio interface module 302, which is typically a wireless network interface card capable of transmitting and receiving wirelessly. Thus, the radio interface module 302 is responsible for transmitting and receiving special beacon frames 200. FIG. 3 also shows the client module 300 connected to a display 304 and receiving user input 306. The user input 306 may be from the mobile device's keyboard, keypad or other input means. The client module 300 comprises an application module 310, a processing unit 312, a beacon generator 314, an outgoing beacon buffer 316 and an incoming beacon buffer 318.

The application module 310 receives user input message 306 from the input means of the mobile client, such as the keyboard or keypad. Upon receipt of the user input message, the application module 310 instructs the processing unit 312 to generate a new special beacon frame. The application module 310 also handles the writing of messages into the message/code subfield 206 in the SSID field 200 of the special beacon frame, as well as any compression and decompression. The message/code subfield 206 contains the user input message written either in a clear format, or in some encoded and/or compressed format. This feature will be described later. The application module 310 also generates a checksum value for the checksum subfield 208.

The processing unit 312 instructs the beacon generator 314 to generate the required special beacon frame. The beacon generator 314 generates the special beacon frame, for example having a modified SSID field in accordance with the format shown in FIG. 2, and passes the generated special beacon frame onto the outgoing beacon buffer 316. The outgoing beacon buffer 316 stores the special beacon frame until the radio interface 302 is ready to broadcast it, whereupon it is passed to the radio interface.

The incoming beacon buffer 318 is used to temporarily store beacon frames received by the radio interface 302, before the beacon frames are passed onto the processing unit 312. The processing unit 312 determines if the beacon frame received is a special beacon frame or a normal beacon frame. If the beacon frame is a normal one, then the beacon frame is processed in the normal manner. However, if the processing unit 312 detects a special beacon frame, for example by the special beacon ID subfield 202, then the processing unit 312 can parse the message/code subfield accordingly and pass the contents to the application module 310 for further processing.

Whilst the various modules within the client module are described and illustrated as separate elements, a person skilled in the art will appreciate that the elements may be grouped together and implemented in shared hardware or software elements, rather than in individual hardware or software modules.

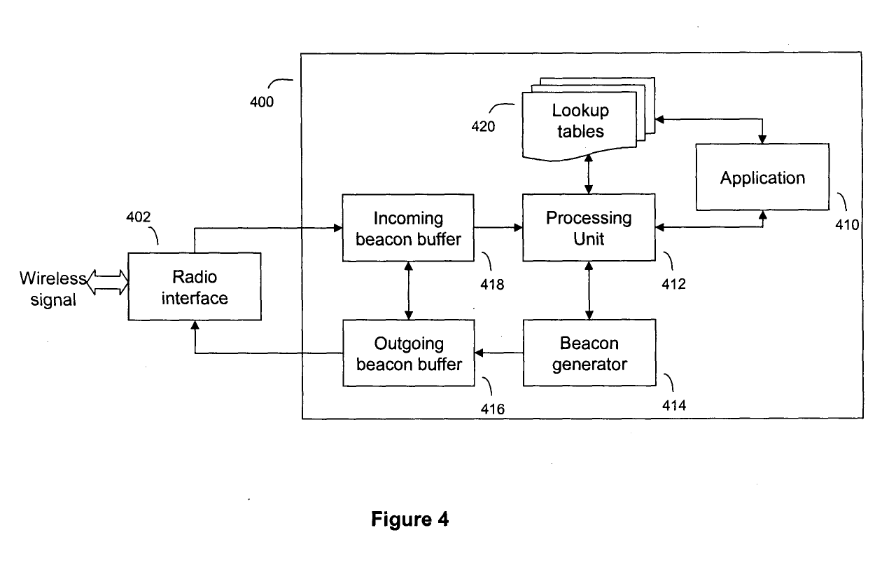

FIG. 4 shows a WAP beacon processing module 400 located in a WAP. The processing module 400 is connected to radio interface 402, which may be any suitable network interface card configured to operate in a wireless LAN. The module 400 receives and retransmits special beacon frames of the type generated by the client module 300 described above. The module 400 is also capable of generating normal beacon frames.

The WAP beacon processing module 400 contains various modules similar to those found in the client module 300 including a

The radio interface 402 receives beacon frames wirelessly. These beacon frames are stored in the incoming beacon buffer 418. The module 400 also includes an outgoing beacon buffer 416, which is used to store outgoing beacon frames. The processing unit 412 parses incoming beacon frames and if the beacon frame is a special beacon frame, for example if it has been tagged with the special beacon ID subfield 202, then the processing unit 412 checks the integrity of the beacon frame using the checksum value. The processing unit 412 or the associated application module 410 may also verify other subfields in the SSID field 200 of the special beacon frame before rebroadcasting the frame. This may include using lookup tables 420 to determine for example authorisation, message routing policy and zone control policy.

Authorization control can be enforced to restrict sending of special beacon frames by clients. The lookup table 420 can list the MAC addresses of clients and neighbouring WAPs that are authorized and participating in the scheme. Thus, upon receiving the special beacon frame, the processing unit 412 will check the respective lookup table and see if the incoming special beacon frame has originated from an authorized client or neighbouring WAP, by checking the MAC address of the sender against those stored in the lookup table. If the sender is in the list, then the special beacon frame will be rebroadcast, otherwise it will be dropped.

Similarly, before broadcasting the special beacon frame, the processing unit 412 can check the lookup table to see if the beacon message actually originated from itself. If it has, then has to be dropped. The lookup table contains a list of beacon messages previously broadcast (identified by checksum), because the receiving next hop WAP will broadcast it back to the original WAP. The lookup table is needed to avoid the “ping-pong” effect. Similar, the previously broadcast special beacons may come back from a third (or fourth) WAP in the chain. This avoids a WAP processing multiple copies of the same beacon frame. So, the lookup table can be used to effectively avoid beacon transmitting back and forth between neighbouring WAPs.

For zone control, the lookup table 420 can be used to determine if the incoming special beacon frame is allowed to be broadcast in the current zone. Special beacon frames from certain zones may not be allowed to be broadcast in the current zone.

The application module 410 is used to manage the information on the lookup tables such as deletion, addition and modification. The processing unit 412 may also control the frequency of the special beacon frame to be rebroadcast after the first broadcast of that frame. This is to increase the likelihood of clients or other participating WAPs detecting or receiving the special beacon frame. For example, the special beacon frames that are received can be rebroadcast two or three times instead of just once.

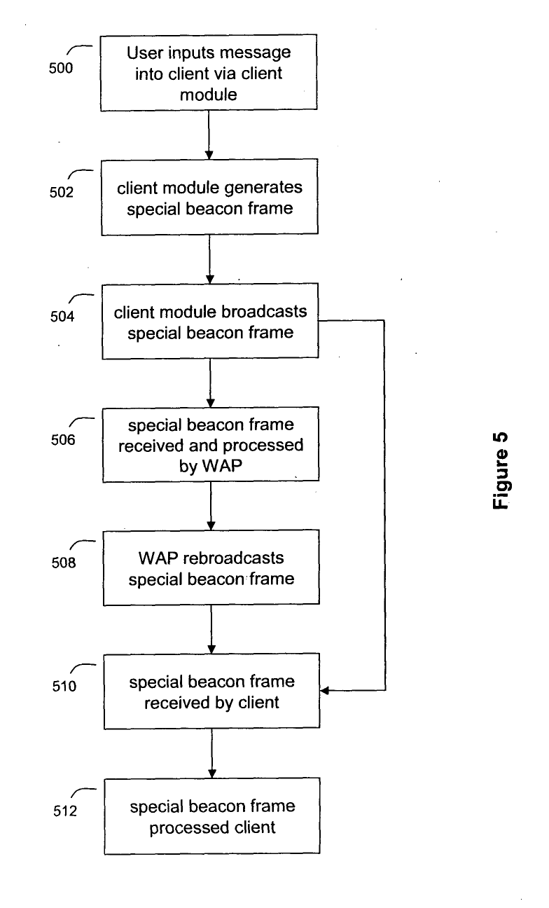

The generation and broadcast of the special beacon frame for user-specified messages by clients, and the subsequent reception and rebroadcast by WAPs for reception by other clients will now be described with reference to the flow chart of FIG. 5.

In step 500 of FIG. 5, a user of a mobile client, such as laptop 120, decides to broadcast a message for receipt by all the other clients 122, 124 and 126 in the local area. For example, the message may relate to an advert such as “BT Openzone at 30 p/hour” or “Discount golf sale on Sesame Street”. The user of the laptop 120 can input a suitable message for receipt by other wireless clients in range by inputting the message into the client module 300 installed on the laptop 120.

In step 502, the client module 300 generates a special beacon frame, which includes a modified SSID field 200 as shown in FIG. 2. The modified SSID field 200 includes a message/code subfield, which contains the user input message either in a clear format or some compressed or encoded form. The additional subfields of the special beacon ID 202, zone ID subfield 204 and checksum subfield 208 may also be included.

The special beacon ID subfield 202 is included to differentiate the special beacon frame from a normal beacon frame. This subfield 202 should consist of a data block that would not normally be used in a normal SSID field, such as the binary sequence of 10101010. Aside from being used to identify a special beacon frame for messaging purposes, the special beacon ID also allows clients to recognise that a WAP broadcasting a beacon frame labelled with the special beacon ID does indeed support the rebroadcast of special beacon frames. Thus, if a client detects a beacon frame broadcast by a WAP having the special beacon ID, the client will know that the WAP supports the rebroadcast of special beacon frames and thus can safely use the special beacon frames for broadcasting user messages, knowing that there is at least one WAP in the locality that supports the service.

In step 504, the client 120 broadcasts the special beacon frame over the air, and the special beacon frame is received by all mobile clients and WAPs in the transmission range.

Processing of the special beacon frame when received directly by another client within range continues in step 510. Processing of special beacon frame continues in step 506, where the special beacon frame is received by a neighbouring WAP, such as WAP 102.

So after receiving the special beacon frame in step 506, the WAP processes the beacon frame. This processing includes first recognising the special beacon frame using the special beacon ID subfield 202. If the WAP receives a beacon frame that does not include the special beacon ID subfield having a recognised value associated with a special beacon frame, the WAP will process the beacon frame normally. Otherwise, if the special beacon ID is present, the WAP can choose whether to rebroadcast the special beacon frame to other nodes in the network or not. This decision can be dependent on various factors such as if the incoming special beacon frame comes from authorized sender, or if the incoming special beacon frame originated from the current WAP, or whether the incoming special beacon frame's zone ID is permitted in the current zone. Rebroadcasting of the special beacon frame occurs in step 508.

The rebroadcast special beacon frame may be received by a neighbouring client or further WAR If the special beacon frame is received by a neighbouring WAP, the processing reverts to step 506. In step 510, the special beacon frame is received by a neighbouring client, such as the smartphone 122.

In step 512, the receiving client processes the special beacon frame. This includes first identifying the special beacon by parsing the special beacon ID subfield 202 within the frame. If no special beacon ID exists, then the client knows that the received beacon frame is a standard beacon frame used to broadcast the SSID of the network for the purpose of connecting to the network. However, in this case, a special beacon ID does exist, so the client knows not to try to make any connection to the node broadcasting the beacon frame, and instead processes it to extract the embedded message.

The client can then extract the message located in the message/code subfield 206 of the special beacon frame.

However, using a modified SSID field 200 to store customized messages does have the limitation that the amount of data that can be stored is restricted, as the beacon frame size is limited. For example a 32 byte field can only store up to 32 ASCII characters. In practice, 1 byte is used for the ID, 1-2 bytes for the zone ID, 2-4 bytes for the checksum, leaving around 28 bytes for the message. In preferred embodiments of the invention, compression can be used to over double the capacity available for messaging to around 56 bytes. Alternatively message codes can be used.

With compression, mobile clients must agree in advance on a compression scheme for compressing a user message in the message subfield 206. Note as WAPs do not actually read the message content, they do not need to know what compression is being used. There are various compression schemes that can be employed. Two of the popular ones are Huffman coding and Lempel-Ziv-Welch (LZW) coding which are used by WinZip, gzip and PKZIP. If the original message is encoded using LZW, then it must later be decoded using the same scheme. Similarly, if Huffman is used by the originating client, the receiving client must use the same Huffman scheme to decode the message. In this invention, it is not important which encoding scheme is applied.

Alternatively, a client may include message codes in the message subfield 206. These codes can be string of characters and/or numbers, which are used instead of longer words or phrases. Receiving clients will then need to access to a message storage server over the Internet in order to translate the message codes into the native messages. Consequently, there is no need to attempt to squeeze the complete message data into the limited message subfield. Furthermore, the size of the message can effectively be unlimited as the delivery of the actual message is via the Internet.

Through this invention, mobile clients do not have to have a network connection with a WAP in order to send or receive customized messages. Compare this to existing WLAN technologies where user messages can only be sent or received if the client is actively connected to a WAP. In public areas, such a service is normally provided by a wireless ISP and has an associated cost. However, for messages such as “advertising”, it is preferable that any user or client can receive them without first having to connect to the network (and pay for the connection). The present invention offers a “connectionless” method for clients to send and received messages.

A client can also use the zone ID subfield 208 in the special beacon frame being broadcast to confine the range of the message being broadcast, and prevent it from being broadcast unendingly. The client module 300 can set the zone ID to a particular zone, so that when a WAP not within the specified zone ID receives the special beacon frame, the WAP will not rebroadcast the frame. The respective zone IDs for each WAP can be assigned based on geographic location, such as by cells.

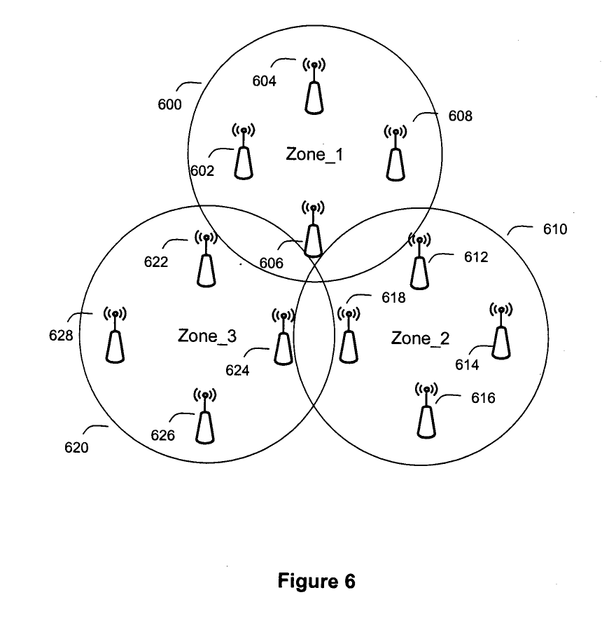

FIG. 6 illustrates the zone boundary management. All WAPs that are located in the same zone are given the same zone ID. In FIG. 6, there are 3 zones shown, Zone_1 600, Zone_2 610 and Zone_3 620. Zone_1 600 includes WAPs 602, 604, 606 and 608. Zone_2 610 includes WAPs 612, 614, 616 and 618. Zone_3 620 includes WAPs 622, 624, 626 and 628.

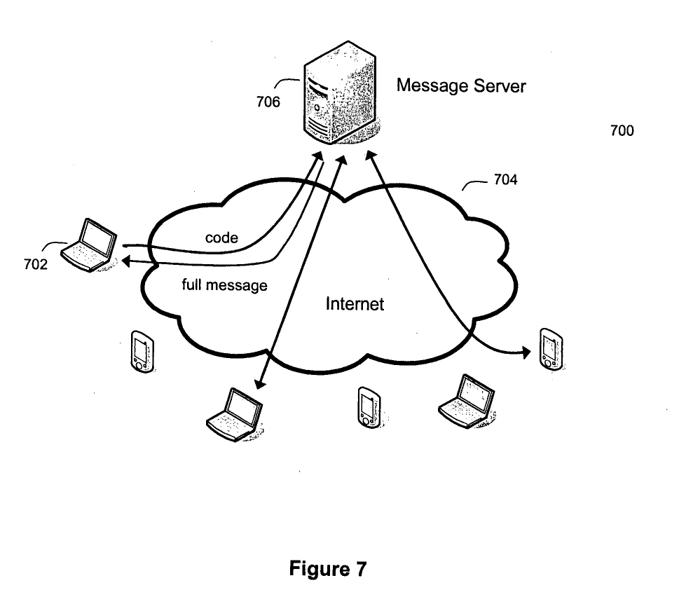

FIG. 7 illustrates the online message retrieval feature. The content of message can be extended significantly using this method by using message codes instead of the raw text/message. Upon receiving a message code in a special beacon frame, a mobile client 702 can connect to a message server 706 online over the internet 704 to retrieve the actual content of the message. This can effectively take the form of a compression technique where short phrases or words are replaced with special codes (letters or numbers), or the system could allow for entire messages to be stored remotely, and their retrieval initiated using a message code linked to the message, similar to a key. To enable the latter feature, the client broadcasting the message would have to connect to the remote message server 706 to store the message and associated message code before generating the special beacon frame.

It is noted herein that while the above describes examples of the invention, there are several variations and modifications which may be made to the described examples without departing from the scope of the present invention as defined in the appended claims. One skilled in the art will recognise modifications to the described examples.

1. A system for broadcasting user messages in a wireless network, said system comprising an access point and a plurality of clients, wherein each client comprises:
a processing unit for receiving a message input by a user,
a generator for generating a beacon frame comprising said input message, and
a broadcast means for broadcasting said generated beacon frame; and wherein each access point comprises:
a receiver for receiving broadcast beacon frames, and
a broadcast means for rebroadcasting said received beacon frames.

2. A system according to claim 1, wherein each client further comprises a receiver for receiving broadcast beacon frames.

3. A system according to claim 1, wherein the processing unit in each client is further adapted to extract the message from the received beacon frame.

4. A system according to claim 3, wherein the generated beacon frame comprises a beacon identifier field for indicating that the beacon frame contains a user input message.

5. A system according to claim 4, wherein the receiver in the access point is adapted to detect the beacon identifier and then extract the message from the received beacon frame.

6. A system according to claim 1, wherein the wireless network is a local area network, and the input message is embedded in a service set identifier field of the beacon frame.

7. A system according to claim 1, wherein the message is compressed in the beacon frame.

8. A system according to claim 1, wherein the message is encoded in the generated beacon frame using an associated message code.

9. A system according to claim 8, wherein the message and associated message code are stored at a message server for retrieval by a client receiving the beacon frame comprising the message code.

10. A method of broadcasting user messages in a wireless network comprising an access point and a plurality of clients, wherein said method comprises:
receiving by a first client a message input by a user,
generating by the first client a beacon frame comprising said input message,
broadcasting by the first client said generated beacon frame,
receiving by the access point the broadcast beacon frames, and
rebroadcasting by the access point the received beacon frames.

11. A client module for a client in a wireless network comprising:
a processing unit for receiving a message input by a user,
a generator for generating a beacon frame comprising said input message, and
a broadcast means for broadcasting said generated beacon frame;
wherein the broadcast beacon frame is for reception and rebroadcasting by an access point in the wireless network.
